(19) United States
(12) Patent Application Publication
(10) Pub. No.: US 2003/0064119 A1
(43) Pub. Date: Apr. 3, 2003

(54) Methods and compositions for applying essential oils and naturally occurring compounds to plants to activate endogenous plant pathogen defense pathways

(76) Inventor: Ralph W. Emerson, Davis, CA (US)

Correspondence Address: RAE-VENTER LAW GROUP, P.C., P.O. BOX 1898, MONTEREY, CA, 93942-1898, US

(21) Appl. No.: 10/176,512

(22) Filed: Jun. 20, 2002

Related U.S. Application Data
(60) Provisional application No. 60/300,374, filed on Jun. 21, 2001.

(51) Int. Cl. A01N 37/36; A01N 37/10; A01N 65/00

(52) U.S. Cl. 424/736; 424/770; 424/739; 514/165; 514/570

(57) ABSTRACT

Compositions and methods are provided for activation of endogenous plant pathogen resistance pathways, including systemic acquired resistance, the hypersensitive reaction response and the upregulation of pathogenesis related proteins. The compositions comprise as active agents one or more naturally occurring compounds or essential oils selected from cedar oil, cinnamon oil, grapefruit oil, grapefruit seed extract oil, ferulic acid and acetyl salicylic acid. The methods involve directly applying formulations comprising one or more of these active agents to a Gymnosperm to induce endogenous plant defense pathways as a therapeutic or prophylactic treatment against fungal pathogens such as pitch canker and white pine blister rust.

### CROSS-REFERENCE TO RELATED APPLICATIONS

The application claims benefit of the filing date of provisional application No. 60/300,374 filed Jun. 21, 2001

### INTRODUCTION

1. Field of the Invention

The invention relates to compositions and methods to activate natural defense pathways and induce systemic acquired resistance in plants to plant pathogens. The compositions include plant defense activation molecules such as essential oils and other naturally occurring compounds and optionally a surfactant. The invention is exemplified by treating pitch canker in a conifer with an aqueous formulation comprising at least one of acetyl salicylic acid, ferulic acid, grapefruit oil, grapefruit seed extract oil, cedar oil and cinnamon oil.

2. Background

Plants are constantly challenged by a wide variety of pathogenic organisms including viruses, bacteria, fungi, and nematodes. Crop plants are particularly vulnerable because they are usually grown as genetically-uniform monocultures; when disease strikes, losses can be severe.

Traditional methods for protecting plants from pathogenic organisms generally require synthetic chemicals that leave residues. It would be desirable to be able treat a plant to activate its own defense pathways against a particular pathogen, either in a therapeutic or prophylactic capacity, such the long-term plant protection could be achieved without the need for repeated applications of chemicals that can leave toxic residues. The chemical S-metolachlor (Bion) is a commercially available compound that activates the system acquired resistance (SAR) pathway. However, due to concerns that enhancement of plant defense pathways might apply selection pressure for stronger pests and pathogens, rotation of plant defense activating substances is desirable, if not necessary.

There is therefore an interest in developing compositions and methods that are both efficacious and environmentally safe and that preferably can be used both therapeutically and prophylactically for control of plant pests through activation of plant defense pathways.

3. Relevant Literature

The association of salicylic acid as a mediator in endogenous plant defense pathways is disclosed in U.S. Pat. Nos. 6,166,291; 5,942,662 and 6,031,153. The association of methyl jasmonate as a mediator in endogenous plant defense pathways, particularly when combined with ethylene, is disclosed in U.S. Pat. Nos. 6,100,451; 6,022,739; 5,981,843 and 5,935,809. Ferulic acid is a known intermediate in the lignin biosynthetic pathway (see U.S. Pat. No. 5,824,842).

### SUMMARY OF THE INVENTION

Compositions containing at least one naturally derived plant defense activator (PDA) molecue and methods of using them are provided for promoting activation of one or more endogenous plant defense mechanisms in a plant. The PDA include acetyl salicylic acid, ferulic acid, and essential oils such as grapefruit oil, grapefruit seed extract oil, cedar oil, and cinnamon oil. The composition can be an aqueous formulation optionally containing one or more surfactant and other compounds that may act to increase the efficacy of the PDA. The method includes the step of providing a plant with a composition comprising one or more PDA. The methods and compositions can be used to facilitate development of short- and long-term endogenous resistance against plant pests in vegetable, fruit and timber plants, and can be used both therapeutically and prophylatically.

### DESCRIPTION OF THE SPECIFIC EMBODIMENTS

Compositions and methods are provided that can be used to activate endogenous protective mechanisms in a plant such as a Gymnosperm against plant pathogens such as pitch canker, white pine blister and rust using PDA molecules. The compositions generally are aqueous and comprise as a PDA at least one naturally occurring compound or essential oil selected from the group consisting of acetyl salicylic acid, ferulic acid, cedar oil, cinnamon oil, grapefruit oil, and grapefruit seed extract oil. Additionally, known mediators in plant pathogen defense pathways, for example methyl jasmonate and related compounds and salicylic acid, find use in the compositions of the subject invention. The compositions optionally comprise one or more emulsifiers, usually a saponin, particularly a saponin obtainable from Yucca shidegera or Yucca quijalla. The methods involve providing a plant susceptible to infection by a pathogen or that is infected by a pathogen with a sufficient amount of a composition that comprises at least one PDA molecule, generally by spraying either the whole plant or susceptible or infected plant parts, such as leaves, stems, roots, trunk, and the like. By endogenous plant defense systems or mechanisms or endogenous plant pathogen resistance pathways are intended pathways that lead to upregulated expression in the plant of pathogenesis defense related proteins (e.g. proteinase inhibitors) (see Casaretto and Corcuera (1995) Biol Res 28:239-249; Bergey, et al. (1996) Proc Natl Acad Sci 93:12053-8; U.S. Pat. Nos. 5,378,819 and 5,935,809), upregulated phytoalexin synthesis, systemic acquired resistance (SAR) (see Dietrich, et al. (1999) Novartis Found Symp 223:205-216; Dong (1998) Curr Opin Plant Biol 1:316-323), and apoptosis, or programmed cell death, also recognized as the hypersensitive reaction (HR) response (see Sandermann (2000) Biol Chem 381:649-53; Heath (2000) Plant Mol Biol 44:321-334; Alvarez (2000) Plant Mol Biol 44:429-442) and synthesis of endogenous pesticidal compounds. In trees, the endogenous protective mechanisms include altered lignification and suberization.

Advantages of the subject invention include efficacy in induction of long-term endogenous plant resistance mechanisms using readily available and relatively inexpensive materials. Because the compositions are comprised of naturally occurring compounds and essential oils, they do not require registration with the FDA. By “natural product” or “naturally occurring” is intended an organic compound of natural origin that is unique to one organism, or common to a small number of closely related organisms, and includes secondary metabolites provided by the organic matter. Importantly, the subject compositions and methods of their use are effective without being phytotoxic to the treated plant.

The PDA molecules can be isolated or obtained from a natural source, be wholly or partially synthetic, or be produced by recombinant techniques. For example, cedar oil can be extracted from Juniperus virginiana, cinnamon oil from Cinnamomum zeylanicum, grapefruit oil and grapefruit seed extract oil from Citrus paradisii, and ferulic acid from coniferous trees. Acetyl salicylic acid is the acetylated form of salicylic acid, which can be extracted from Salicaceae trees. The PDA generally are obtained from commercial suppliers and used without further purification. The compositions generally are prepared as a concentrated aqueous formulation by combining at least one PDA in water to produce a concentrate of at least 10%, preferably at least about 20%, 30%, 40% or 50%, and for certain applications at least about 60%, 70%, 80% or 90% PDA. Immediately prior to use, the concentrated formulation is diluted with water to a concentration to be used for application to the plants to be treated. For plants other than trees, the application concentration is in the range of about 0.001%, 0.01%, 0.1%, or 1.0% PDA, but sometimes 3.0%, 5.0% or 10.0% PDA and for trees the application concentration is in the range of about 0.001%, 0.01%, 0.1%, or 1.0% PDA, but sometimes 3.0%, 5.0% or 10.0% PDA.

A particular formulation can have one active agent or more than one active agent. When preparing a formulation with more than one active agent, it is preferable to choose agents that function synergistically in activating distinct plant defense pathways. For some formulations, it will be desirable to combine an exogenous activating agent, that is not an endogenous mediator of a plant defense pathway with an endogenous activating agent, this is known to be a mediator of a plant defense pathway. Methyl jasmonate and salicylic acid are both endogenous activating agents that can be applied externally to a plant to induce an endogenous pathogen defense response. Representative derivatives of methyl jasmonate that find use in the subject invention include jasmonic acid, 7-iso-jasmonic acid, 9,10-dihydrojasmonic acid, 2,3-didehydrojasmonic acid, 3,4-didehydrojasmonic acid, 3,7-didehydrojasmonic acid, 4,5-didehydrojasmonic acid, 5,6-didehydrojasmonic acid, 6,7-didehydrojasmonic acid, 7,8-didehydrojasmonic acid, and the lower alkyl esters, the carrier ligand conjugates and the stereoisomers thereof.

An active agent of particular interest is ferulic acid, also known as 3-(4-hydroxy-3-methoxyphenyl)-2-propenoic acid; 4-hydroxy-3-methoxycinnamic acid; 3-methoxy-4-hydroxycinnamic acid; and caffeic acid 3-methyl ether. Both the cis and/or trans isomers can find use in the subject compositions, as well as other related naturally occurring phenolic compounds, including ferulate, diferulate, 8-8′ diferulate, cinnamic acid, cinnamic aldehyde, and coniferyl aldehyde, 5-caffeoylquinic acid (chlorogenic acid), neochlorogenic acid, hydroxybenzoic acid, 5-p-feruloylquinic acid, protocatechuic acid, 4-caffeoylquinic acid, ethyl 3-(4′-geranyloxy-3-methoxyphenyl)-2-propenoate, sinapic acid, and vanillic acid, epicatechin, o-coumaric acid, p-coumaric acid, tyrosol, syringic acid, caffeic acid, gallic acid; 3,4-dihydroxybenzoic acid; cis-coumaroyl tartaric acid (COUTA); trans-COUTA; trans-caffeoyl tartaric acid (CAFTA), and other hydroxycinnamic esters. Also of interest are dimeric, dehydrodimeric, and trimeric forms of polymerized ferulic acid (see Ward, el al. (2001) J Biol Chem 276:18734).

Another active agent of particular interest is cedar oil. Active components comprised in this essential oil include oil of cedarwood, the terpene cedrene, and cedrol (also known as cedar camphor or cypress camphor). Other names for cedrol include [3R-(3α,3αβ,6α,7β,8aα)]-octahydro-3,6,-8,8-tetramethyl-1H-3α,7-methanoazulen-6-ol and 8βH-cedran-8-ol. Derivatives and metabolites of cedrol that are of use in the subject invention include 3beta-hydroxycedrol, 3alpha-hydroxycedrol and 12-hydroxycedrol, transgeraniol, eugenol, and a-terpineol.

In addition to the PDA set forth above, derivatives of any of these compounds that produce a PDA upon action of a biological system on a precursor are considered to be equivalent to compounds of the invention. Thus application of precursor compounds to plant surfaces which can metabolize the precursors to produce a specific PDA is equivalent to the practice of the present invention. Also, additional components (other than the active agents) can be added to the formulation to modulate the effect of at least one other compound present in the formulation whereby the combined action is greater than that without the addition of components and preferably is synergistic with the components of the active agents in the formulation. By synergistic is intended that the activity of the formulation with the additional component as compared to a formulation which does not contain the component is greater than would be expected by adding the effects together.

Preferred additional components in the compositions include saponins. Saponins are a class of compounds, each consisting of a sapogenin portion and a sugar moiety. The sapogenin may be a steroid or a triterpene and the sugar moiety may be glucose, galactose, a pentose, or a methylpentose, for example. S. Budavari, ed., The Merck Index, 11 th ed., Merck & Co., Inc., Rahway, N.J., 1990, p. 1328. Saponins for use in the present formulation include sterol glycosides widely distributed in plants, wherein each saponin consists of a sapogenin and at least one sugar moiety. The sapogenin comprises a steroid or a triterpene and the sugar moiety may comprise glucose, galactose, pentose, or methylpentose. The saponins for use in the present invention can be produced and/or isolated from various plant parts including fruit, leaf, seed and/or root, using means known in the art, from a variety of sources including the various plants known to produce them, ranging from yucca, quillaja, agave, tobacco, licorice, soybean, ginseng and asparagus to aloe woods. Saponins have diverse activities which are attributable to the chemical make-up of a particular saponin and most typically are dependent on the source form which the saponin is derived. Saponins for use in the present invention are preferably non-toxic to humans and higher animals. Most preferably the saponin for use in the present invention is a non-toxic food grade saponin, the source being, yucca plants with the most preferred saponins being derived from Yucca schidigera or Y. valida and their equivalents. Yucca schidigera saponin is obtained from Danco Natural Products, Pine Valley, Calif., and is sold as Yucca Ultra (containing about 10-11% saponin) or Pure Yucca (about 7-14% saponin). Saponins from Yucca schidigera contain steroidal saponins with the major sapogenins being sarsapogenin and tigogenin. The sarsaponin yields on hydrolysis, sarsasapogenim (sarsasapogenim 5-beta, 20-betaF, 22-deltaF, 25-betaF; also known as spirostan-3-beta-01 and parigenin), glucose and galactose. The sarasapogenim has a molecular formula of C₂₇H₄₄O₃. Nobel, Park S., Agaves, Oxford Univ. Press, New York, 1994. Accordingly, derivatives of these compounds which produce a formulation having the desired emulsification and/or resistance-inducing properties are considered equivalents of the invention. As appropriate, it is preferable to select a saponin that increases the endogenous plant pathogen resistance inducing effect of a formulation as compared to a formulation that excludes the saponin.

The effect of saponin as an additional component in the formulation is determined empirically by the addition of varying amounts of saponin admixed or applied separately in combination with a given PDA. The effect of the formulation is measured by examining the susceptibility of particular pathogens to each formulation with or without a serial dilution of saponin. The amount of saponin used generally is in the range of about 0.01%, 0.1%, 0.5%, 1.0%, 2.0%, 3.0%, 5.0% v/v aqueous solution of 10° brix saponin extract. 10° brix is a term of art in sugar chemistry. The brix degrees equals the percent by weight of sugar in the solution. Hawley, ed., The Condensed Chemical Dictionary, 10th ed., Van Nostrand Reinhold, New York, 1981, p. 149.

The method of the present invention is carried out by introducing to an infected or susceptible plant surface a sufficient amount of an endogenous plant resistance response-inducing agent to impair growth and/or viability of the target pathogen and thereby decrease infection and/or infection susceptibility in the treated area. In use, the subject formulations containing the endogenous pathogen resistance-inducing agent is introduced to an area of whole plants or plant parts of a single plant infected with a target pathogen. The compositions comprising may be used either alone or in combination with other active or inactive substances and may be applied by spraying, pouring, dipping, in the form of concentrated liquids, solutions, suspensions, powders and the like, containing such concentration of the active compound(s) to evoke activation of the endogenous pathogen resistance pathways that enable the short-term resolving of an infection or long-term protection from an infection. Generally, the formulation is sprayed on as a wet or dry formulation on the surface of organic material infected with a target pathogen. The formulation is usually air dried on the treated plant surface and the dry residues of the active agents on the surface initiate an appropriate plant pathogen resistance pathway. Alternatively, the formulation can be applied wet or dry to an area of plants or plant parts susceptible to be infected by a target pathogen. The method of introduction of the subject formulations is generally by direct application, but certain active agents can induce a plant pathogen resistance response mechanisms through volatile or airborne exposure. The method of use of the formulations will depend at least in part upon the plant to be treated and the target pathogen. For example, a formulation including the PDA can be directly sprayed onto a target pest.

Alternatively, the formulations may be encapsulated in a polymer shell and applied in the form of microcapsules. In an application of inducing endogenous resistance pathways to a plant pathogen, the shell material is preferably a biodegradable material, such as beeswax, carnauba wax, gelatin, sucrose, starch or dextran, so that the shell can be degraded to release the subject compounds to the target pathogen. To encapsulate the subject compound in a polymer, a first prepolymer is dissolved in the core material of the subject compound. The resulting solution is then dispersed in the continuous phase (usually water), which usually contains one or more dispersing agents. A second prepolymer may then added to the resulting emulsion. A shell wall forming reaction occurs at the oil/water interface of the emulsion droplets. The resulting suspension of microcapsules which encapsulated the subject compound can then be further formulated to produce the final product. The size of microcapsules is generally 0.1 to 50 microns, and preferably 1 to 20 microns.

Where solid, time-release or extended/controlled release formulations are used, for example in areas which are subject to re-infection, or where extended exposure of the plant to the active ingredient further enhances the efficacious induction of pathogen resistance pathways the dosage used is typically on the order of about 0.1 to 20%, and preferably at 0.5 to 10%. Analytical chemical techniques are used to determine and optimize rate of release. For qualitative purposes, GC techniques can be used to determine the amount of active agent released. The samples of encapsulated (pelletized) product are sampled at different time periods to measure release. Alternatively, volatile gases released from the formulation can also be analyzed. For measuring the activity of spray or powder applications, the stability of the formulations over time can also be evaluated by the GC methodology using techniques known to those skilled in the art. Methanol or alcohol extractions of the formulations also can be prepared and evaluated by HPLC analysis.

The compositions and methods of the present invention can be used to kill and/or confer resistance and/or repel a wide array of plant pathogens, which include viruses or viroids such as tobacco or cucumber mosaic virus, ringspot virus or necrosis virus, pelargonium leaf curl virus, red clover mottle virus, tomato bushy stunt virus, and like viruses; Ascomycete fungi such as of the genera Venturia, Podosphaera, Erysiphe, Monolinia, Mycosphaerella, and Uncinula; Basidiomycete fungi such as from the genera Hemileia, Rhizoctonia, and Puccinia; Fungi imperfecti such as the genera Botrytis, Helminthosporium, Rhynchosporium, Fusarium (i.e., F. monoliforme, F. circinatum), Melampsora (i.e., M. pinitorqua Rostr. (pine twist rust)), Cronartium (i.e. C quercuum fusiforme or fusiform rust; C. ribicola or white pine blister rust), Septoria, Cercospora, Alternaria, Pyricularia, and Pseudocercosporella (i.e., P. herpotrichoides); Oomycete fungi such as from the genera Phytophthora (i.e., P. parasitica), Peronospora (i.e, P. tabacina), Bremia, Pythium, and Plasmopara; as well as other fungi such as Scleropthora macrospora, Sclerophthora rayissiae, Sclerospora graminicola, Peronosclerospora sorghi, Peronosclerospora philippinensis, Peronosclerospora sacchari and Peronoscierospora maydis, Physopella zeae, Cercospora zeae-maydis, Colletotrichum graminicola, Gibberella zeae, Exserohilum turcicum, Kabatiellu zeae, and Bipolaris maydis; bacteria such as Pseudomonas syringae, Pseudomonas tabaci, and Erwinia stewartii; insects such as aphids, e.g. Myzus persicae; and lepidoptera such as Heliothus spp.; and nematodes such as Meloidogyne incognita.

The susceptibility of particular pathogens to the subject compositions and methods can be evaluated as follows. The efficacy of the formulations to be used therapeutically on plants already sustaining a pathogen infection, or prophylactically on plants susceptible to a pathogen infection is carried out with treated and untreated (control) plants, where the untreated plants are treated with an identical formulation lacking an active agent (carrier or blank control). For example, evaluation of the appropriate concentration of PDA to use for therapeutic treatment of a particular pathogen is carried out by infecting a plant of interest with a target pathogen and then treating with an active agent formulation. A prophylactic treatment of can be evaluated by treating a plant with at least one application of a formulation comprising an active agent and then inoculating the plant with a target pathogen.

Examples of plants that are treatable by the subject compositions and methods include evergreens, particularly woody perennial plants and tree crops such as eucalyptus, poplar and pine species. As used herein, “woody perennial plant” encompasses perennials such as trees, dwarf trees and shrubs. The method of the present invention may be applied to any tree, including both angiosperms and gymnosperms, particularly conifers. As used herein, the term “conifer” refers to a member of the order Coniferae in the sub-phylum Gymnospermae in the phylum Spermaphyta. Exemplary conifers which may be used in practicing the present invention are the members of the family Pinaceae, which include, for example, loblolly pine (Pinus taeda), slash pine (Pinus elliotii), longleaf pine (Pinus palustris), shortleaf pine (Pinus echinata), ponderosa pine (Pinus ponderosa), jack pine (Pinus banksiana), Eastern white pine (Pinus strobus), Western white pine (Pinus monticola), sugar pine (Pinus lambertiana), lodgepole pine (Pinus contorta), Monterey pine (Pinus radiata), Afghan pine (Pinus eldarica), Scots pine (Pinus sylvestris), and Virginia pine (Pinus virginiana); spruces such as the black spruce and the white spruce (genus Picea); Douglas fir (Pseudotsuga menziesii); hemlock species (such as Tsuga canadensis); spruce species (such as Picea mariana, Picea rubens, Picea glauca and Sitka spruce); redwood (Sequoia sempervirens); the true firs including silver fir (Abies amabilis), grand fir (Abies grandis), noble fir (Abies procera), white fir (Abies concolor), balsam fir (Abies balsamea); and the cedars which include Western red cedar (Thuja plicata), incense cedar (Libocedrus decurrens), Port Oxford cedar (Chamaecyparis lawsoniona), and Alaska yellow-cedar (Chamaecyparis nootkatensis); and Western larch (Laryx occidentalis). Angiosperms suitable for treatment include forest trees belonging to the genus Eucalyptus, Liquidambar (e.g, sweetgum), Liriodendron (e.g., yellow-poplar), Platanus (sycamore), Populus (e.g., cottonwoods, poplars, aspens) and domesticated trees such as those belonging to the genus Prunus (e.g., cherries and plums).

The subject compositions are useful alone and in the enhancement of traditional management strategies for plant pests and pathogens. Use of PDA compositions comprising naturally occuring compounds and essential oils will afford plants increased protection from disease and pests when applied prophylactically and expedited recovery of infected plants such that they sustain less severe damage. When using PDA compositions of the subject invention, less frequent applications of residual-based pesticides are required, if any are required at all.

The following examples are offered by way of illustration of the present invention, not limitation.

### EXAMPLES

### Example 1

### Administration of Naturally Occurring Compounds to Induce Resistance to Fusarium circinatum in (Pinus radiata)

The trees to be treated are 2-3 years old, growing in five-gallon pots, and maintained in a glasshouse. At the outset of the experiment, all trees are inoculated on each of two branches to provide an estimate of their susceptibility to pitch canker. A standard procedure is used, which involves introducing a known quantity of spores of the pitch canker pathogen (Fusarium circinatum) into a small wound. Approximately 30 days after the inoculation the bark is removed at the inoculation site and the length of the lesion induced by the pathogen is measured. Based on mean lesion lengths, trees are placed into between two and four susceptibility groups, depending on the range of variation that is observed.

1) Test Compounds to Establish the Extent to which they Affect the Response of Treated Trees to Subsequent Challenge with the Pitch Canker Pathogen

Eighteen trees that have been placed into susceptibility categories are used in tests for induction of resistance. Each of the five candidate materials are applied to three trees by spraying to run-off, and three trees are left untreated (treated with the carrier only as a control). Each group of three trees includes equal numbers from each of the pre-determined susceptibility categories. Forty-eight hours after treatment, all 18 trees are challenged with the pitch canker pathogen by inoculating three branches per tree, using the method described above. Lesion lengths are measured 30 days later, and means computed for each treatment. Analysis of variance is used to test for a significant treatment effect. If this effect is significant means comparison tests are used to establish which of the treatments corresponded to mean lesion lengths significantly shorter than the non-treated control. A significant reduction in lesion length is taken as evidence of induced resistance. If the above experiment yields positive results for any of the tested materials, the experiment is repeated in a similar fashion to provide confirmation.

2) Test Compounds to Determine if they Enhance the Resistance of Trees Already Infected with the Pitch Canker Pathogen.

In parallel with the above experiment, an additional set of 18 trees are tested to determine if the test compounds affect the course of the disease in trees already infected with pitch canker. All eighteen trees are inoculated on each of three branches. Two weeks later, each of the five test compounds is applied to three different trees, three trees remain untreated (carrier only as a control). Forty-eight hours later, all the trees are inoculated at a different location on each of the three previously inoculated branches. Thirty days after the final inoculation, lesion lengths are scored. If the lesions develop to a lesser extent on the treated trees than on the control trees, this is an indication that the treatment has enhanced the resistance of those trees.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporate by reference.

The invention now having been fully described, it will be apparent to one of ordinary skill in the art that many changes and modifications can be made thereto without departing from the spirit or scope of the appended claims.

What is claimed is:

1. A method of inducing an endogenous pathogen defense pathway in a plant, said method comprising the step of:
providing said plant with a composition comprising at least one compound selected from the group consisting of ferulic acid, acetyl salicylic acid, cinnamon oil, grapefruit oil, cedar oil and grapefruit seed extract oil and an emulsifier.

2. The method according to claim 1, wherein said emulsifier is a saponin.

3. The method according to claim 1, wherein said plant is a Gymnosperm.

4. The method according to claim 3, wherein said Gymnosperm is a conifer.

5. The method according to claim 3 wherein said pathogen is Fusarium circinatum or Cronartium ribicola.

6. A method of inducing a plant to develop long-term resistance to a pathogen, said method comprising the step of:
contacting said plant with a composition comprising at least one compound selected from the group consisting of ferulic acid, acetyl salicylic acid, cinnamon oil, grapefruit oil, cedar oil and grapefruit seed extract oil and an emulsifier.
